(19) United States
(12) Patent Application Publication
(10) Pub. No.: US 2007/0108834 A1
(43) Pub. Date: May 17, 2007

(54) BALANCE WEIGHT CARTRIDGE WITH ENCLOSED BALANCE MEDIA

(76) Inventors: Robert D. Fogal SR., Chambersburg, PA (US); Robert D. Fogal JR., Newville, PA (US)

Correspondence Address: HAHN LOESER & PARKS, LLP, One GOJO Plaza, Suite 300, AKRON, OH, 44311-1076, US

(21) Appl. No.: 11/559,604

(22) Filed: Nov. 14, 2006

Related U.S. Application Data
(63) Continuation-in-part of application No. 11/276,867, filed on Mar. 17, 2006, now Pat. No. 7,134,731.
Application No. 11/276,867 is a continuation-in-part of application No. 11/306,397, filed on Dec. 27, 2005, now Pat. No. 7,192,096.
Application No. 11/306,397 is a continuation of application No. 10/806,671, filed on Mar. 23, 2004, now Pat. No. 6,979,060.
(60) Provisional application No. 60/488,634, filed on Jul. 18, 2003.

(51) Int. Cl. B60B 27/00

(52) U.S. Cl. 301/5.22

(57) ABSTRACT

A weight comprising a cartridge having at least one interior chamber, the interior chamber at least partially filled with a flowable balance media, and wherein the cartridge is longitudinally arcuate, at least when attached to a wheel, about an angle of up to 180 degrees or less. The weight provides a balanced tire in the new or just balanced condition and helps retain the balance under changes in at least one operational characteristic of the tire/wheel assembly.

This application is a continuation in part of U.S. non-provisional patent application Ser. No. 11/276,867, filed Mar. 17, 2006, which is a continuation in part of U.S. non-provisional patent application Ser. No. 11/306,397, filed Dec. 27, 2005, which is a continuation of U.S. non-provisional patent application Ser. No. 10/806,671, filed Mar. 23, 2004, now U.S. Pat. No. 6,979,060, issued Dec. 27, 2005, which claims the benefit of U.S. provisional patent application Ser. No. 60/488,634, filed Jul. 18, 2003; all of which are hereby incorporated by reference.

### TECHNICAL FIELD

This invention relates to the reduction of vibration in tire/wheel assemblies operating under different speeds and changing tire properties.

### BACKGROUND

A motor vehicle may be characterized as comprising an unsprung mass and a sprung mass. The unsprung mass includes parts of the vehicle not supported by the vehicle suspension system such as the tire/wheel assembly, steering knuckles, brakes and axles. The sprung mass, conversely, includes parts of the vehicle supported by the vehicle suspension system. The unsprung mass can be susceptible to disturbances and vibration from a variety of sources such as worn joints, misalignment of the wheel, brake drag, irregular tire wear, etc. Because vehicular tires support the sprung mass of a vehicle on a road surface and such tires are resilient, any irregularities in the uniformity or dimensions of the tire, any dimensional irregularities in the wheel rim, and/or any dynamic imbalance or misalignment of the tire/wheel assembly may cause disturbances and vibrations to be transmitted to the sprung mass of the vehicle thereby producing an undesirable or rough vehicle ride, as well as reducing handling and stability characteristics of the vehicle. Severe vibration can result in undesirable conditions such as wheel tramp or hop and wheel shimmy (shaking side-to-side).

It is now standard practice to reduce some of these adverse vibrational effects by balancing the wheel rim and tire assembly by using a balance machine and clip-on lead weights or lead tape weights. The lead balance weights are placed on the rim flange of the wheel and clamped in place in a proper position, or adhered to the wheel in the case of tape weights, as directed by the balancing machine. By one definition, balance is the uniform distribution of mass about an axis of rotation, where the center of gravity is in the same location as the center of rotation. A balanced tire/wheel assembly is one where the mass of the tire/wheel assembly mounted on the vehicle's axle is uniformly distributed around the axle. Balancing is an improvement that reduces the vibration of the tire/wheel assembly in comparison to an unbalanced tire/wheel assembly.

However, even perfect balancing of the tire/wheel assembly does not necessarily mean that the tire will roll smoothly. Even a perfectly balanced tire can have severe vibrations due to non-uniformities in the tire, which result in unequal forces within the tire footprint.

A level of non-uniformity is inherent in tires. In the art of manufacturing pneumatic tires, rubber flow in the mold or minor differences in the dimensions of the belts, beads, liners, treads, plies of rubberized cords or the like, sometimes cause non-uniformities in the final tire. These non-uniformities can be determined using force variation machines which measure the forces acting on a tire under load. Forces on a tire that is rolling under load on a road may be broken down into three orthogonal components, which will be referred to herein as: radial, lateral, and tangential. Radial forces act in the tire's radial direction, i.e., perpendicular to the tire's axis of rotation. Radial forces are strongest in the vertical direction (e.g., wheel “hop”) as the tire interacts with the road surface, but may also have a horizontal (fore-aft, or “surge”) component due to, for example, the radial centrifugal force of a net mass imbalance in the rotating tire. Lateral forces act in a direction parallel to the tire's axis of rotation, and generally occur where the tire's surface touches the road surface. Lateral force causes either tire wobble or a constant steering force. Tangential force, or fore-aft force is experienced at the surface of contact between tire and road surface in a direction both tangential to the tire's outer circumference (e.g., tread surface) and perpendicular to the tire's axis of rotation (thus also perpendicular to the radial and lateral forces). Tangential force variations are experienced as a “push-pull” effect on a tire. When non-uniformities are of sufficient magnitude, they cause force variations on a surface, such as a road, against which the tires roll and thereby produce vibrational disturbances in the vehicle upon which the tires are mounted. Regardless of the cause of the force variations, when such variations exceed an acceptable minimum level, the ride of a vehicle utilizing such tires may be adversely affected.

Contrary to radial force variations, which are generally not speed dependent, tangential force variations vary greatly with speed. Tangential force variations are generally insignificant below 40 mph; however, tangential force variations surpass radial force variations as the dominant cause of unacceptable vibration of a balanced tire rotating at over 60 mph and can quickly grow to be a magnitude of twice the radial force variation at speeds approaching 80 mph. Currently, there are no viable methods for reducing tangential force variations. Studies have shown that grinding does not reduce tangential force variation (Dorfi, “Tire Non-Uniformities and Steering Wheel Vibrations,” Tire Science & Technology, TSTCA, Vol. 33, no. 2, April-June 2005 p 90-91).

Tire uniformity machines are relatively expensive, and their use is generally limited to tire companies and automotive vehicle companies. Tire shops try to minimize the effect of tire non-uniformity by matching up the harmonic high point of the tire (typically marked with a yellow dot representing the lightest part of the tire) with the harmonic low point of the rim (typically the valve stem representing the heaviest part of the wheel). This requires that the tire manufacturer and the wheel manufacturer measure and mark these locations on each of their products in a standard fashion and that the mark does not get removed in some manner over the life of the tire and wheel. Even if this is done, the tire shop has no knowledge of the magnitude of the non-uniformity of the tire. Therefore, if the tire/wheel assembly is balanced and matched but the vibration problem persists, the tire shop may recommend a different tire.

The tire non-uniformity vibration problem has proliferated with the introduction of ever larger passenger and light truck tires that are installed on sports utility vehicles, luxury vehicles, and light trucks. In order to be capable of handling these non-uniformity problems, many tire shops are turning to balancing machines such as the Hunter® GPS9700 balancer, which provides the capability to measure radial force variation, a significant factor in vibration caused by tire non-uniformity. The GPS9700 Road Force Measurement® System uses a roller to apply up to 1,400 lbs. of pressure against the tire/wheel assembly. The load simulates the weight of the vehicle. As the tire is rotated, the equipment measures the variations in the tire's radial force. Using this information, the operator can use the measured data which includes the high harmonic area on the tire to match together with the low harmonic spot on a rim to cancel vibration caused by radial force variation in the same manner discussed above. After the tire is matched to the wheel, the tire/wheel assembly can be balanced and then rechecked to determine the resulting radial force variation. Using balancing machines such as the GPS9700 provides a magnitude of radial force variation for the tire. Published limits indicate that the radial force variation that most vehicles will tolerate is 18 lbs or less for tires on passenger cars, 24 lbs or less on light trucks, and 30 lbs or less for LT tires on light trucks. These can be stringent limits for tire manufactures with regard to limiting their scrap tire production. Further, some tire manufacturers dispute results from some machines, such as the Hunter® GPS9700 balancer.

While gains have been made in the ability of an average tire shop to diagnose, measure, and correct vibration of a tire/wheel assembly due to imbalance, run out, and non-uniformity force variations, there remains a need in the art to provide stability to the unsprung mass of the vehicle to combat tires that may have excessive force variations due to non-uniformity. Accordingly, a weight for a tire/wheel assembly is needed for reducing vibration in tire/wheel assemblies operating under different speeds and changing tire properties.

### SUMMARY OF THE DISCLOSURE

At least one disadvantage of the prior art is overcome by providing a weight comprising a receptacle having an opening, a flowable media at least partially filling the receptacle, a lid capable of closing the receptacle, and an adhesive on an exterior surface of the receptacle or the lid.

A tire/wheel assembly disclosed may comprise a wheel rim, a tire mounted on the wheel rim, and a weight mounted onto a non-pressurized side of the wheel rim, the weight comprising a tray comprising a receptacle, a flowable media at least partially filling the receptacle, a lid closing the receptacle and being affixed to the tray, and an adhesive on an exterior surface of the weight attaching the weight to the wheel rim.

A method of attaching a single weight to a tire/wheel assembly may comprise the steps of providing a tire/wheel assembly; providing a single weight comprising a tray comprising a receptacle, a flowable media at least partially filling the receptacle, a lid closing the receptacle and being affixed to the tray, and an adhesive on an exterior surface of the weight; and attaching the weight by the adhesive to a non-pressurized side of a tubewell of the tire/wheel assembly or a non-pressurized side of a rim flange of the tire/wheel assembly, and attaching the weight to the wheel rim about an angle of 180 degrees or less.

A method of attaching a plurality of weights to a tire/wheel assembly may comprise the steps of providing a tire/wheel assembly, providing a plurality of weights, each weight comprising a tray comprising a receptacle, a flowable media at least partially filling the receptacle, a lid closing the receptacle and being affixed to the tray, and an adhesive on an exterior surface of the weight, and attaching the plurality of weights to a non-pressurized side of a tubewell of the tire/wheel assembly or a non-pressurized side of a rim flange of the tire/wheel assembly such that the plurality of weights, in combination, do not extend 360 degrees about the rotational axis of the tire/wheel assembly when the weights are attached to the wheel.

A tire/wheel assembly disclosed may comprise a wheel rim, a tire mounted on the wheel rim, and a weight mounted onto a non-pressurized side of the wheel rim, the weight comprising a receptacle between two film layers sealed on three or more edges, a flowable media at least partially filling the receptacle, and an adhesive on an exterior surface of the receptacle.

In any of the foregoing embodiments, the weight may be flexible between a flat and an approximately arcuate shape. The weight may comprise a tray that was manufactured by thermoforming. The flowable media in the weight may occupy between 5 and 95 percent of the receptacle volume.

### BRIEF DESCRIPTION OF THE DRAWINGS

FIG. 1 is a perspective view of one embodiment of a balance weight of the present disclosure;

FIG. 2 is an exploded perspective view of a mounting side of the weight of FIG. 1;

FIG. 3 is a cross-sectional view through the weight of FIG. 1;

FIG. 4 is an top view of the weight of FIG. 1;

FIG. 5 is an elevational side view of the weight of FIG. 1;

FIG. 6 is an exploded perspective view of a further embodiment of the balance weight having a circular shape;

FIG. 7 is an exploded perspective view of a further embodiment of the balance weight having two interior cavities;

FIG. 8 is a perspective view of an embodiment of the balance weight attached to the brake side of the tube well of a tire/wheel assembly;

FIG. 9 is a top view showing relative sizes of three embodiments of the weight of the present disclosure;

FIG. 10 is a partial side view of a wheel with a further embodiment of the present disclosure mounted to a wheel rim flange;

FIG. 11 is a cross-sectional view of the wheel rim flange and weight through the section marked 11-11 in FIG. 10;

FIG. 12 is a cross-sectional view through a further alternate embodiment of the weight of the present disclosure; and

FIG. 13 is a cross-sectional view through an alternate embodiment of the weight of FIG. 12.

### DETAILED DESCRIPTION OF THE DRAWINGS

Related balance weight embodiments have been disclosed in previous co-owned patent applications, including but not limited to the disclosure of U.S. Pat. No. 6,979,060, issued Dec. 27, 2005, and hereby incorporated by reference. These applications disclosed a tube type of weight cartridge having an interior chamber at least partially filled with flowable material. The present disclosure provides an alternate way to form an inner chamber containing flowable material.

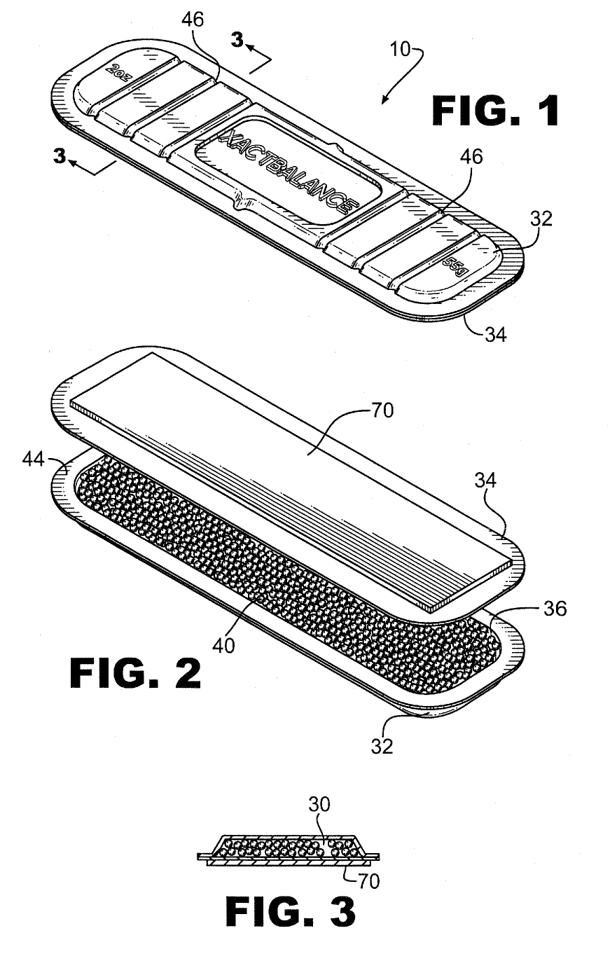

Referring now to FIGS. 1 through 5, a balance weight 10 is provided comprising an interior chamber 30. In one embodiment, the weight 10 comprises a receptacle 36 having an opening, forming at least a portion of the interior chamber 30.

In the embodiment of FIGS. 1 and 2, the interior chamber 30 is formed between a tray 32 comprising the receptacle 36, and a lid 34. The lid 34 is capable of closing the receptacle 36 for retaining a flowable media 40 in the interior chamber 30. In this embodiment, the receptacle 36 is formed within the tray 32, and the lid 34 is affixed to the tray 32 to close the receptacle 36.

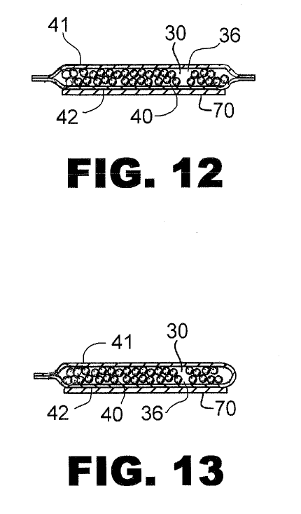

In an alternate embodiment shown in FIGS. 12 and 13, the interior chamber 30 is sealed between a first layer 41 of film material and an adjacent second layer 42 of film material. In this embodiment, the receptacle 36 is created by sealing the perimeter of the adjacent first and second layers 41, 42 of film material.

In the embodiment of FIG. 2, the weight 10 comprises a flange 44 about the receptacle 36. In one embodiment, the lid 34 is affixed to the flange 44.

One or more adhesive strips 70 may be provided on an exterior surface of the weight for attaching the weight to a wheel. In the embodiment of FIGS. 1 and 2, the adhesive strip 70 is provided on an exterior surface of the lid 34 for attaching the weight to a wheel. Alternately, one or more adhesive strips 70 may be provided on an outer surface of the tray 32. The adhesive may be an acrylic adhesive capable of holding the weight to the wheel in a selected range of tire/wheel assembly operating temperatures. It is contemplated that adhesives other than acrylic may be provided.

In this embodiment, the weight 10 may be flexible between a flat and an approximately arcuate shape. Ribs 46 may be provided to facilitate or provide relief for flexing the tray between the flat and approximately arcuate shapes. In one embodiment, the ribs 46 are provided in the receptacle 36.

In the embodiment of FIG. 1, the weight is manufactured in a flat shape. Before an operator installs the weight onto a wheel, the operator may flex the weight into a shape that approximately matches the shape of the mounting surface. In one operational embodiment, the weight 10 is mounted to the non-pressurized side of a tubewell of the tire/wheel assembly or a non-pressurized side of a rim flange of the tire/wheel assembly, and the weight is flexed into an approximately arcuate shape that approximately matches the radius of the mounting surface of the wheel.

The lid 34 may be a flat sheet, as indicated by FIG. 2. In one embodiment, the lid 34 is the same shape as the tray 32, thereby providing a larger interior chamber 30. It is contemplated that the lid may comprise any suitable shape for closing the receptacle 36 and forming the interior chamber 30. In one embodiment, the ribs 46 are formed in the lid.

It is contemplated that the interior chamber 30 may be formed by joining two trays 32 together such that the openings of each receptacle 36 face together and the interior chamber 30 comprises a volume approximately the sum of the volume of each separate tray receptacle. In this embodiment, one of the joined trays functions as a lid for the other tray 32.

In the embodiment of FIG. 5, the ribs 46 are formed into the tray 32 such that the ribs extend into the interior chamber 30. In one embodiment, the ribs 46 extend into the tray 32 approximately the depth of the tray to limit the flow of media in the chamber 30. In one embodiment, the ribs 46 extend in an outward direction to not limit the flow of media through the interior chamber 30.

The tray 32 may be manufactured by thermoforming the tray from a sheet of thermoplastic material, and then die cutting a perimeter around the receptacle 36 to create the flange 44. After filling the tray receptacle with flowable media 40, the lid 34 may be affixed to the tray 32 by sonic welding, vibration welding, heat staking, snap fitting features, adhesives, fasteners, or other methods for connecting the lid 34 to the tray 32.

The lid 34 may be connected to one side of the flange 44 by forming and die cutting the lid and the tray as one piece. In this embodiment, after the tray is filled with flowable material, the lid may be folded over to cover the tray receptacle and then affixed to close the tray.

The tray and lid may be made from a material suitable for thermoforming, such as but not limited to polyethylene, polypropylene, polyester, PVC, ABS, or other plastic material. In one operating environment, the weight 10 may be exposed to a wide range of temperatures and various chemicals and grime. It is contemplated that the tray and lid may be manufactured with any flexible thermoplastic material having suitable toughness and temperature and chemical resistance. In one embodiment, the tray 32 and lid 34 are made by forming a thin film having a thickness less than 0.010 inch (0.25 millimeter) comprising polyester, polyethylene, or other suitable polymer. In an alternate embodiment, the tray 32 and lid 34 are made from a metallic material.

In one embodiment, the tray 32 and lid 34 are manufactured by injection molding. Alternately, the tray 32 and lid 34 may be manufactured by pressure forming, stamping or cold forming, extrusion, or any other suitable manufacturing process for creating the tray and lid.

The weight 10 may comprise a tray having a relatively wide receptacle to allow movement of the media adjacent the wheel in both a circumferential direction as well as a lateral direction to balance the wheel in two planes.

In one embodiment, the weight 10 is a low-profile configuration, as indicated by FIG. 5, which enables the weight 10 to be positioned on the inboard side of the wheel without contacting the brake components.

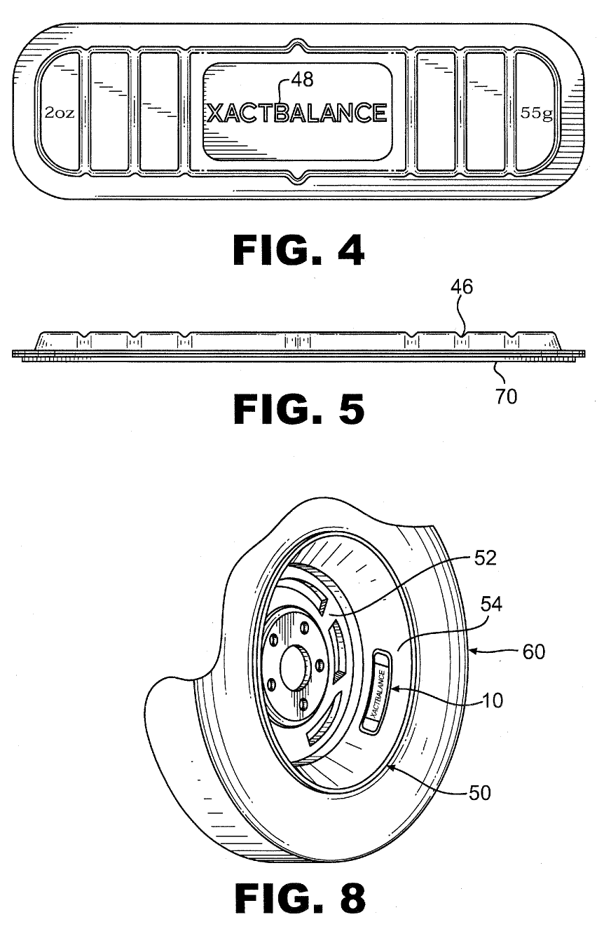

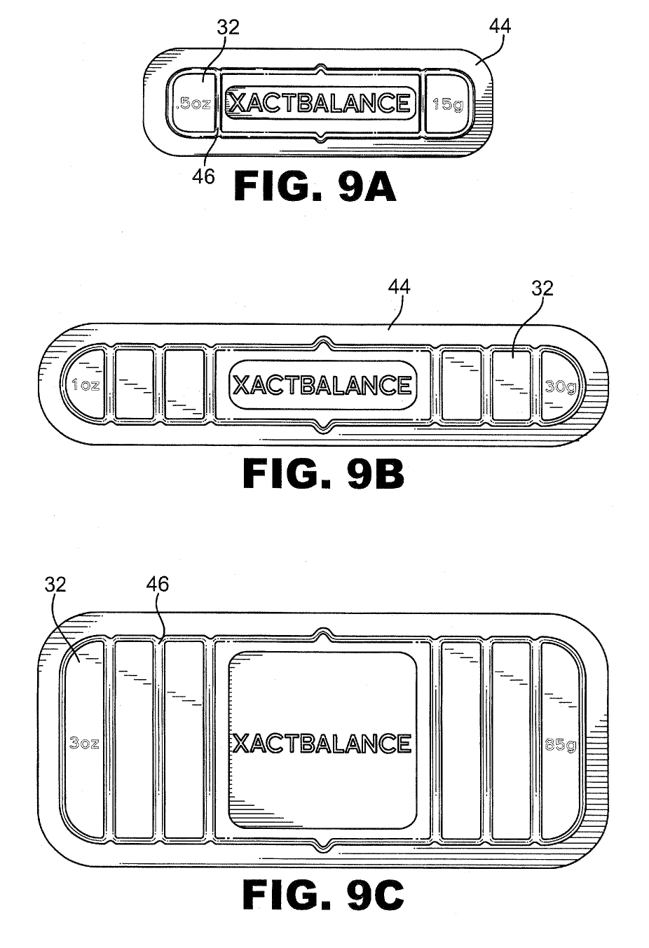

The weight 10 may comprise a logo 48. The logo shown in FIGS. 4 and 9 is the XACT BALANCE® trademark. However, it is contemplated that other logos may be provided, including trademarks of retailers, tire manufacturers, suppliers, distributors, or others. The weight 10 may be offered as a marketing premium with custom colors and logos provided. In this embodiment, the logo 48 is provided on a surface of the weight opposite of the adhesive, such that the logo is visible when the weight is mounted to the wheel. The logo 48 may be formed into the receptacle 36 or lid 34. Alternately, the logo 48 may be applied by hot stamp, heat transfer, label, or any other graphical printing, application, or embossment.

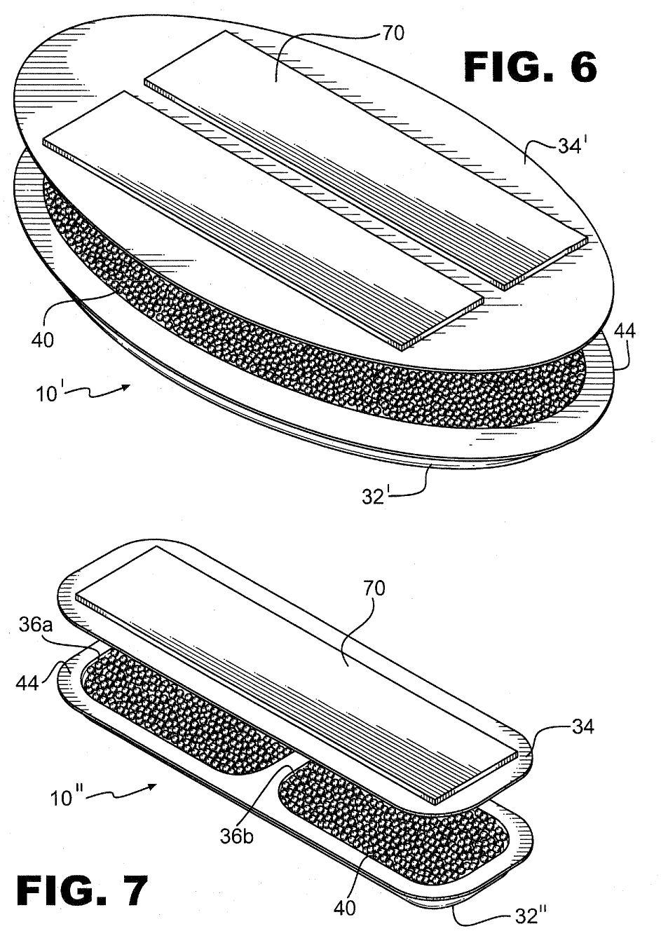

In the embodiment of FIG. 6, the weight 10 comprises an arcuate shape, such as a circle or oval shape. In this embodiment, an arcuate shaped tray 32′ is at least partially filled with flowable media 40, and closed by a lid 34′.

In the embodiment of FIG. 7, the weight 10 comprises more than one chamber 30. In this embodiment, the tray 32″ has two or more receptacle compartments, designated as 36a and 36b in FIG. 4. The multiple chambers may provide additional structural rigidity by providing an interior wall to further attach the lid. The incorporation of multiple chambers may also limit the movement of the media between receptacle compartments 36a, 36b, which in some instances may help the media to balance the wheel by providing movement of the media in more than one chamber.

In the thin film embodiment of FIG. 12, the first layer 41 of film material is positioned adjacent the second layer 42 of film material and the sides and bottom edges of the layers are sealed together to form the receptacle 36, as a pouch, having an opening at the top. Then, the pouch, or receptacle 36, is filled with an amount of the flowable media 40 to fill between 5 to 95 percent of the volume of the receptacle 36. In one embodiment, the amount of flowable media 40 exceeds 95 percent of the volume of the receptacle 36. After the flowable media 40 is placed into the receptacle 36, the top edges of the layers 41, 42 are sealed together to close the interior chamber 30.

Alternately, as shown in FIG. 13, the first layer 41 and the second layer 42 may be one piece of film material folded over onto itself, such that the receptacle 36 is created by sealing together the top edges, bottom edges, and the edges on the side opposite of the fold. In this embodiment, the film material is folded over and the bottom and side edges of the layers 41, 42 are sealed together to form the receptacle 36, as a pouch, having an opening at the top. Then the receptacle 36 is filled with the selected amount of the flowable media 40. After the flowable media 40 is placed into the receptacle 36, the top edges of the layers 41, 42 are sealed together to close the interior chamber 30.

The weight 10 of FIG. 12 and 13 may further comprise one or more of the adhesive strips 70 provided on an exterior surface of the first layer 41 or the second layer 42. The logo 48 may be provided on the side opposite of the adhesive 70. In this embodiment, the logo 48 may be applied by hot stamp, heat transfer, label, or any other graphical printing, application, or embossment.

In the embodiments of FIG. 12 and 13, the receptacle 36 may be made and filled with a vertical form fill and seal machine known in the packaging industry. In one embodiment, the weight 10 comprises a flexible and resilient thin film having a thickness less than 0.010 inch (0.25 millimeter) comprising polyester, polyethylene, or other suitable polymer.

The flowable media 40 may be metallic balls, such as but not limited to stainless-steel. However, any suitable flowable material is contemplated, including beads, shot, particles, powders, etc. made of ceramic material, glass material, polymeric material, metallic material, or other ferrous and non-ferrous metals, ceramics, plastics, glass beads, alumina, etc. It is also contemplated that the flowable material may be a liquid, in whole or in part. Such suitable materials may include any material that is stable and remains free flowing over various operating conditions of the tire/wheel assembly. The size of the individual material of the flowable media 40 is small enough that it can flow in an interior chamber 30 having a relatively small height. It is contemplated that the flowable material may include a lubricating agent such as talc or graphite that may help the material enhance and/or retain its flowable characteristics.

Referring now to FIG. 8, an embodiment of the balance weight 10 is shown attached to a wheel 50 of a tire/wheel assembly 60 by the adhesive 70. In some embodiments, the weight may be mounted to aesthetic aluminum alloy wheels where a consumer may not want the weight to be visible. Accordingly, the weight 10 may be mounted to the non-pressurized side of the tubewell 54 or a non-pressurized side of the rim flange of the tire/wheel assembly using the adhesive 70. Alternately, the weight 10 may be mounted on the inboard side of the spider 52 along the brake side of the tubewell 54 of the wheel 50. In one embodiment, the weight 10 is longitudinally arcuate when attached to the wheel rim about an angle of 180 degrees or less.

In one embodiment, the amount of flowable media 40 within the balance weight 10 is sufficient to enable at least one balance weight 10 to balance the tire/wheel assembly. In use, one or more balance weights 10 may be applied in the same manner as a standard lead balance weight, as shown in FIG. 8. In one balancing method, the tire/wheel assembly is mounted on the spin balancer and the out of balance condition is detected. The spin balancer recommends an amount of weight to be positioned at a particular circumferential position and at a particular predetermined distance from the axis in one or more predetermined planes. The mass of one or more balance weight 10 mounted (including the weight 10 and flowable media 40) may be equivalent to the amount of weight called for by the balance machine.

Various specified weights may be provided by increasing the size of the interior chamber 30 by increasing the size of the tray, as indicated by FIG. 9. A variety of predetermined sizes of tray 32 may be provided for achieving different sizes of interior chamber 30. The amount of flowable media 40 provided in the interior chamber 30 may be proportional to the specified weight with larger imbalances requiring a larger tray 32 and more flowable media 40, and vise versa.

It is contemplated that the amount of flowable media 40 used in the weight 10 may vary between 5 to 95 percent of the receptacle volume. In one embodiment, the amount of flowable media 40 used in the weight 10 may vary between 5 to 95 percent of the volume of the interior chamber 30. In one embodiment, the amount of flowable media 40 is approximately two-thirds of the volume of the interior chamber 30. We have found that filling approximately two-thirds of the volume of the interior chamber 30 with flowable media 40 provides optimized dynamic balancing for some tested wheel assembly embodiments. However, any amount sufficient to allow the flowable material to sufficiently move and balance the tire/wheel assembly is contemplated. In some applications where the lead balance weight is merely replaced, more than 95 percent of the receptacle volume may be filled with media 40 such that the balance weight 10 acts as a fixed weight.

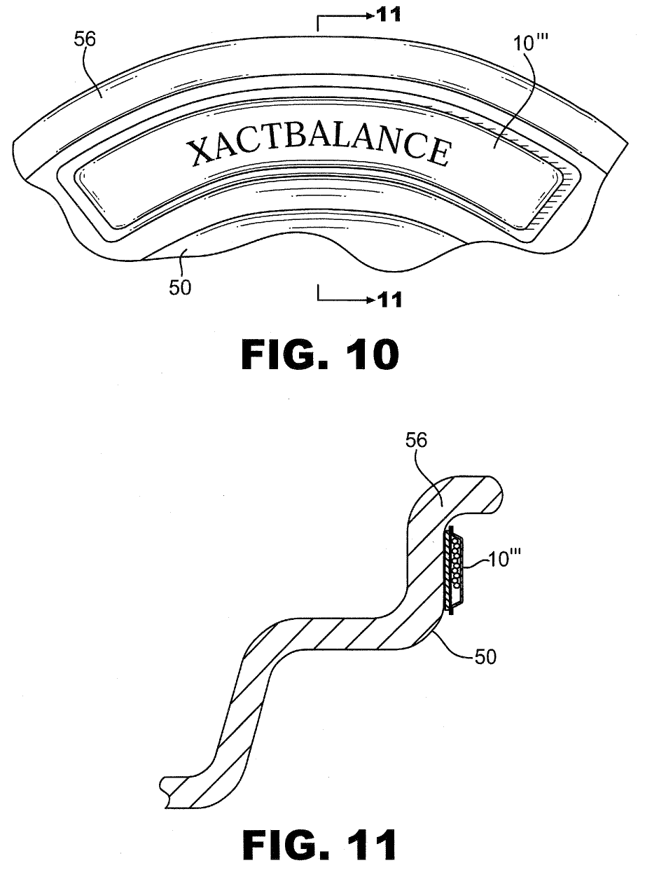

The weight of the present disclosure may be formed in a shape that conforms to a predetermined surface. In the embodiment of FIGS. 10 and 11, the weight 10′″ comprises a tray 32′″ that is formed in an arcuate shape approximately matching the radius of a wheel flange 56. In a thermoformed embodiment, the tray may be molded to correspond to any suitable surface on the wheel 50.

It is contemplated that for some tire/wheel assemblies, a single balance weight 10 will be sufficient to balance the tire/wheel assembly. Alternately, for some tire/wheel assemblies, a plurality of balance weights 10 may be used to balance a wheel, as with the prior art lead balance weights. The balance weight 10 is applied in the same manner as are the tape weights as instructed by the particular balance weight machine (not shown), using either single plane or dual plane balancing.

The flowable media 40 in the balance weight 10 has the ability to help dampen minor vibration of the tire/wheel assembly due to various causes such as tire uniformity problems. This helps promote a smoother ride for the occupants of the vehicle.

While this invention has been described with reference to specific embodiments, it shall be understood that such description is by way of illustration and not by way of limitation. Accordingly, the scope and content of the present invention are to be defined only by the terms of the appended claims.

What is claimed is:

1. A weight for a tire/wheel assembly comprising:
a. a receptacle having an opening;
b. a flowable media at least partially filling the receptacle;
c. a lid capable of closing the receptacle; and
d. an adhesive on an exterior surface of the receptacle or the lid.

2. The weight according to claim 1, where the receptacle is a tray.

3. The weight according to claim 2, the tray comprising a flange outwardly extending from the tray.

4. The weight according to claim 3, the lid being affixed to the flange by welding.

5. The weight according to claim 1, the weight being flexible between a flat and an approximately arcuate shape.

6. The weight according to claim 1, further comprising:
one or more ribs formed in the receptacle.

7. The weight according to claim 1, the flowable media occupying between 5 and 95 percent of the receptacle volume.

8. The weight according to claim 1, the flowable media occupying more than 95 percent of the receptacle volume.

9. The weight according to claim 1, the adhesive being positioned on a surface of the lid.

10. The weight according to claim 1, the media comprising a ceramic material, a glass material, a polymeric material, or a metallic material.

11. The weight according to claim 1, the receptacle being manufactured by thermoforming.

12. The weight according to claim 1, further comprising a logo formed in the receptacle.

13. A tire/wheel assembly comprising:
a. a wheel rim;
b. a tire mounted on the wheel rim; and
c. a weight mounted onto a non-pressurized side of the wheel rim, the weight comprising a receptacle having an opening, a flowable media at least partially filling the receptacle, a lid capable of closing the receptacle, and an adhesive on an exterior surface of the receptacle or lid attaching the weight to the wheel rim.

14. The tire/wheel assembly according to claim 13, the weight being longitudinally arcuate when attached to the wheel rim about an angle of 180 degrees or less.

15. The tire/wheel assembly according to claim 13, the weight being mounted to a non-pressurized side of a tubewell of the tire/wheel assembly.

16. The tire/wheel assembly according to claim 13, the weight being mounted to a non-pressurized side of a rim flange of the tire/wheel assembly.

17. A method of attaching a single weight to a tire/wheel assembly comprising the steps of:
a. providing a tire/wheel assembly;
b. providing a single weight comprising a receptacle having an opening, a flowable media at least partially filling the receptacle, a lid capable of closing the receptacle, and an adhesive on an exterior surface of the receptacle or lid; and
c. attaching the weight by the adhesive to a non-pressurized side of a tubewell of the tire/wheel assembly or a non-pressurized side of a rim flange of the tire/wheel assembly about an angle of 180 degrees or less.

18. The method according to claim 17, further comprising the step of:
before the step of providing a single weight, determining the mass and location of the weight by using a balancing machine.

19. The method of attaching a plurality of weights to a tire/wheel assembly comprising the steps of:
a. providing a tire/wheel assembly;
b. providing a plurality of weights, each weight comprising a receptacle having an opening, a flowable media at least partially filling the receptacle, a lid capable of closing the receptacle, and an adhesive on an exterior surface of the receptacle or lid; and
c. attaching the plurality of weights to a non-pressurized side of a tubewell of the tire/wheel assembly or a non-pressurized side of a rim flange of the tire/wheel assembly such that the plurality of weights, in combination, do not extend 360 degrees about the rotational axis of the tire/wheel assembly when the weights are attached to the wheel.

20. The method according to claim 19, further comprising the step of:
before the step of providing a plurality of weights, determining the mass and location of the weights by using a balancing machine.

21. A tire/wheel assembly comprising:
a. a wheel rim;
b. a tire mounted on the wheel rim; and
c. a weight mounted onto a non-pressurized side of the wheel rim, the weight comprising a receptacle between two film layers sealed on three or more edges, a flowable media at least partially filling the receptacle, and an adhesive on an exterior surface of the receptacle.

22. The tire/wheel assembly according to claim 21, the weight being flexible between a flat and an approximately arcuate shape.

23. The tire/wheel assembly according to claim 21, the flowable media occupying between 5 and 95 percent of the receptacle volume.
